(19) United States
(12) Patent Application Publication
(10) Pub. No.: US 2005/0260018 A1
(43) Pub. Date: Nov. 24, 2005

(54) Image forming apparatus

(75) Inventors: Jae-young Jang, Suwon-si (KR); Se-byun Lyu, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/133,288

(22) Filed: May 20, 2005

(30) Foreign Application Priority Data
May 22, 2004 (KR) 2004-36671

(51) Int. Cl. G03G 21/00; G03G 21/12

(52) U.S. Cl. 399/358; 399/360

(57) ABSTRACT

An image forming apparatus has at least one developing unit that removes waste toner from a photosensitive medium using a cleaning unit and temporarily stores the waste toner. A waste toner storage tub communicates with the developing unit when the developing unit is mounted on a main body and stores the waste toner exhausted from the developing unit.

### CROSS REFERENCE TO RELATED APPLICATIONS

This application claims the benefit under 35 U.S.C. § 119(a) of Korean Patent Application No. 2004-36671, filed on May 22, 2004, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus having a waste toner container that is attachable and detachable from the image forming apparatus so that waste toner removed from a photosensitive medium is not stored in a developing unit but is stored separately.

1. Description of the Related Art

Generally, an image forming apparatus, such as a printer, produces electrostatic latent images on a photosensitive drum in response to print data using an exposure unit. Toner is supplied as a developing agent to the electrostatic latent images to form the electrostatic latent images as toner images. The toner images are transferred and fused to print paper, thereby obtaining a desired image.

Thus, the image forming apparatus includes a developing unit that supplies toner to the surface of the photosensitive medium on which the electrostatic latent images are formed and develops the electrostatic latent images as the toner images. The developing unit is an assembly storing toner, and is adapted to be attached to and detached from a main body.

FIG. 1 is a side cross-sectional view of a conventional developing unit. A developing unit 10 is installed to be attached to and detached from a main body (not shown) and includes a toner storage tub 20 that is surrounded by a housing 11 and stores toner T. An agitator 21 is installed in the toner storage tub 20 and agitates the toner T so that the toner T is not solidified.

The developing unit 10 also includes a photosensitive drum 22, a portion thereof being exposed to a housing 11, on which an electrostatic latent image is formed by light irradiated from an exposure unit (not shown). A developing roller 23 is installed to be adjacent to the photosensitive drum 22 and supplies toner T to the electrostatic latent image to form a toner image. A supplying roller 24 is installed under the toner storage tub 20 and supplies the toner T dropped from the toner storage tub 20 to the developing roller 23.

The developing unit 10 also includes a metering blade 25, one end thereof being fixed in the housing 1 and the other end thereof regulating the thickness of the toner T supplied to the surface of the developing roller 23. A charging roller 26 contacts the photosensitive drum 22 and charges the photosensitive drum 22 to a predetermined potential. A cleaning blade 27 contacts the surface of the photosensitive drum 22 and removes waste toner remaining after the toner image is transferred to print paper (not shown). A waste toner storage tub 28 stores the waste toner removed from the cleaning blade 27.

The waste toner removed from the photosensitive drum 22 using the cleaning blade 27 is stored in the waste toner storage tub 28. The waste toner accumulated and stored in the waste toner storage tub 28 is accumulated in the vicinity of the cleaning blade 27. Due to the accumulated waste toner, the function of the cleaning blade 27 is degraded as time elapses, and consequently, the efficiency of a cleaning operation of the photosensitive drum 22 is lowered.

To solve this problem the size of the waste toner storage tub 28 may be increased, but the size of the developing unit would also be increased. Accordingly, there is a need for an improved waste toner storage container.

### SUMMARY OF THE INVENTION

The present invention provides an image forming apparatus having an additional waste toner storage tub in which waste toner removed from a photosensitive medium using a cleaning unit is exhausted outside of a developing unit and is stored therein.

According to an aspect of the present invention, an image forming apparatus includes at least one developing unit removing waste toner from a photosensitive medium using a cleaning unit and temporarily storing the waste toner. A waste toner storage tub communicates with the developing unit when the developing unit is mounted on a main body and stores the waste toner exhausted from the developing unit.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and advantages of the present invention will become more apparent by describing in detail exemplary embodiments thereof with reference to the attached drawings, in which:

FIG. 1 is a side cross-sectional view of a conventional developing unit;

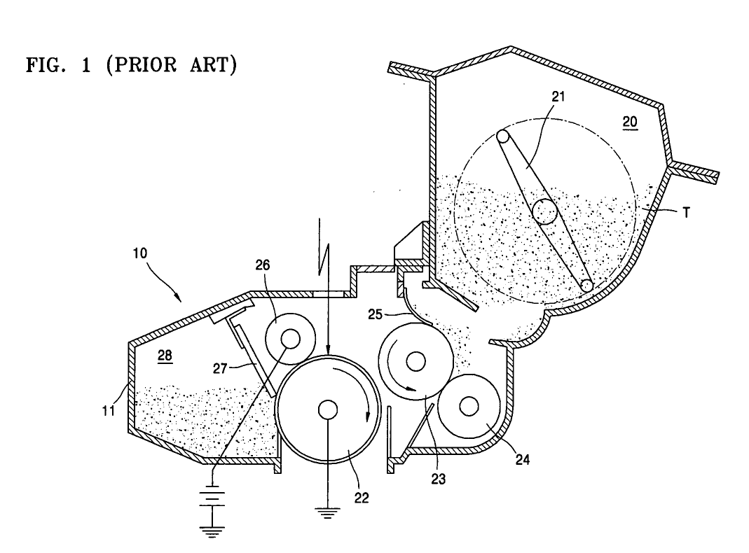

FIG. 2 is a schematic diagram of an image forming apparatus having a waste toner storage tub according to the present invention;

FIG. 3 is an elevational cross-sectional view of the waste toner storage tub and a developing unit according to the present invention; and

FIG. 4 is a partial elevational cross-sectional view in which the waste toner storage tub and the developing unit are combined with each other.

Throughout the drawings, like reference numerals will be understood to refer to like parts, components and structures.

### DETAILED DESCRIPTION OF EXEMPLARY EMBODIMENTS

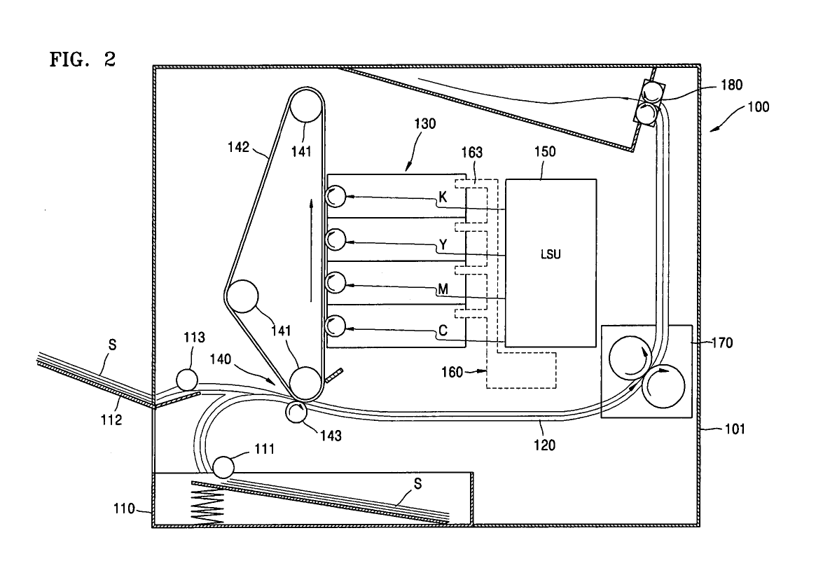

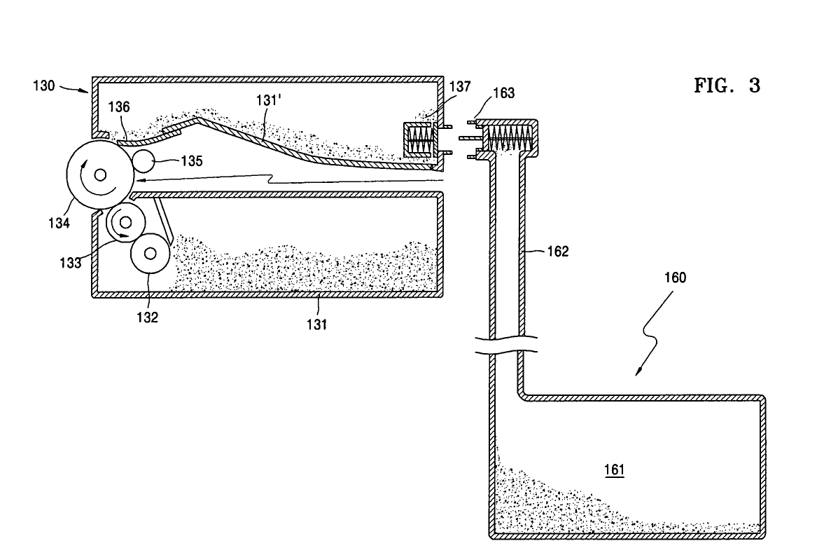

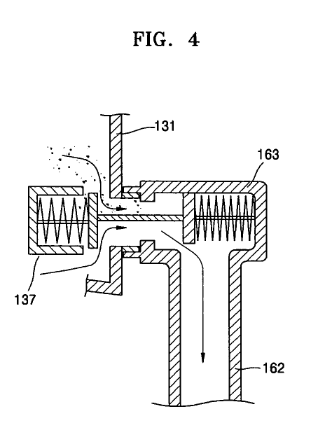

FIG. 2 shows the structure of an image forming apparatus having a waste toner storage tub according to the present invention. FIG. 3 is a side cross-sectional view of the waste toner storage tub and a developing unit according to the present invention. FIG. 4 is a partial side cross-sectional view in which the waste toner storage tub and the developing unit are combined with each other.

Referring to FIGS. 2 and 3, an image forming apparatus 100 has a paper cassette 110 on which print paper S is mounted and that is installed under a main body 101 to be attached and detached to and from the image forming apparatus 100. A multipurpose paper feeding board 112 is installed at a side portion of the main body 101 and on which the print paper S is mounted. Pickup rollers 111 and 113 pick up the print paper S sheet by sheet and are installed on the paper cassette 110 and the multipurpose paper feeding board 112, respectively. The print paper S picked-up by the pickup rollers 111 and 113 is transferred to an inside of the main body 101 along a transfer path 120 and is exhausted outside of the main body 101 after an image is formed.

The image forming apparatus 100 has a developing unit 130, a transfer unit 140, an exposure unit 150, a waste toner storage tub 160, a fusing unit 170, and a paper exhausting unit 180, which are disposed along the transfer path 120.

The developing unit 130 supplies toner as a developing agent to an electrostatic latent image formed on a photosensitive medium to develop the electrostatic latent image as a toner image. The developing unit 130 is installed to be attached to and detached from the main body 101 and has a photosensitive drum 134 whose portion is exposed to a housing 131. A developing roller 133 is installed in the housing 131 and supplies the developing agent to the photosensitive drum 134 to form a toner image. A supplying roller 132 supplies the developing agent to the developing roller 133.

The developing unit 130 has a charging roller 135 that charges the photosensitive drum 134 to a predetermined potential. A cleaning unit 136 contacts the surface of the photosensitive drum 134 and removes waste toner remaining on the surface of the photosensitive drum 134 after the toner image is transferred to the print paper S. A cleaning blade or cleaning roller may be used as the cleaning unit 136.

A plurality of developing units 130 are vertically arranged, as shown in FIG. 2. Each of the developing units 130 stores developing agents of four colors, such as yellow (Y), magenta (M), cyan (C), and black (K), and thus may form color images. A developing unit having a K color may be used to form a black-and-white image without using the other developing units having the other colors, Y, M, and C.

The waste toner removed from the cleaning unit 136 flows in a downward direction along an inclined portion 131′ formed in the housing 131. A connection valve 137 that communicates with a waste toner storage tub 160 is disposed in the housing 131 toward which the waste toner flows.

The transfer unit 140 has an intermediate transfer belt 142 supported and rotated by a plurality of rollers 141. Toner images formed with each K, Y, M, and C color are transferred to the intermediate transfer belt 142 and overlap with one another. A transfer roller 143 is installed to face the intermediate transfer belt 142 and to transfer a color image to the print paper S.

The toner images formed with each K, Y, M, and C color are transferred from the photosensitive drum 134 while the intermediate transfer belt 142 is rotated, thereby forming a color image.

The exposure unit 150 forms the electrostatic latent image on the surface of the photosensitive drum 134 by radiating light on the photosensitive drum 134. The exposure unit 150 radiates light irradiated from one light source using a laser scanning unit (LSU) on a plurality of photosensitive drums 134 via several paths. A plurality of laser scanning units may be used to correspond to the plurality of photosensitive drums 134.

The waste toner storage tub 160 has a waste toner container 161 that is installed to be attached to and detached from the main body 101 and stores the waste toner therein. An inlet portion 162 extends from the waste toner container 161 by a predetermined distance. A plurality of connection parts are connected to the inlet portion 162.

The connection parts 163 are adapted to be connected to the connection valve 137 that is employed at one side of the developing unit 130 and to communicate with the connection valve 137. The waste toner temporarily stored in the developing unit 130 is transferrred to the waste toner container 161 from the connection valve 137 to the connection parts 163 via the inlet portion 162.

The connection valve 137 may be closed so that the waste toner does not leak outside the developing unit 130 when the developing unit 130 is separated from the main body 101. Additionally, the connection valve 137 may be opened so that the waste toner leaks outside the developing unit 130 while contacting the connection parts 163 when the developing unit 130 is mounted on the main body 101.

The connection parts 163 may be closed when the developing unit 130 is separated from the main body 101, and be opened when the developing unit 130 is mounted on the main body 101 so that the connection parts 163 communicate with the connection valve 137 and the waste toner flows.

The connection valve 137 and the connection parts 163 may be check valves that control the image forming apparatus 100 so that the waste toner flows in the waste toner container 161 from the developing unit 130, that is, so that the waste toner flows only in a direction.

The connection valve 137 and the connection parts 163 may have a variety of shapes that communicate with one another when they contact and are closed when they are separated from one another.

Additionally, the inlet portion 162 is placed in a substantially vertical direction from the waste toner container 160 and the plurality of connection parts 163 are formed in the inlet portion 162, because the plurality of developing units 130 are disposed in the vertical direction. Thus, when the plurality of developing units 130 are disposed in a horizontal direction, the inlet portions 162 may be disposed in the horizontal direction so that the connection parts 163 are connected to the developing units 130. That is, the inlet portion 162 is disposed to be connected to the developing units 130 depending on the manner in which the developing units 130 are arranged.

The connection parts 163 may be inclined at a predetermined angle so that the connection parts 163 communicate with the connection valve 137 and the waste toner easily flows in the waste toner container 161.

The fusing unit 170 fuses the toner image on the print paper S by applying heat and pressure on the toner image transferred to the print paper S.

The paper exhausting unit 180 exhausts the print paper S on which the toner image is fused to the outside.

The operation of inflowing the waste toner in the waste toner storage tub having the above structure according to the present invention will be described with reference to FIGS. 3 and 4.

As shown in FIG. 3, when the developing unit 130 is separated from the main body 101, the connection valve 137 is closed so that the waste toner does not leak outside the developing unit 130. The connection parts 163 of the waste toner storage tub 160 mounted on the main body 101 are closed.

As shown in FIG. 4, when the developing unit 130 is mounted on the main body 101, the connection valve 137 and the connection parts 163 contact one another and communicate with one another. The waste toner flows in a direction indicated by the arrows and is stored in the waste toner container 161.

As described above, in the image forming apparatus according to exemplary embodiments of the present invention, waste toner removed from a photosensitive medium is exhausted outside of a developing unit such that the volume of the waste toner is reduced, the size of the developing unit is reduced and the waste toner is prevented from being solidified in the developing unit.

While the present invention has been particularly shown and described with reference to exemplary embodiments thereof, it will be understood by those skilled in the art that various changes in form and details may be made therein without departing from the spirit and scope of the invention as defined by the following claims.

1. An image forming apparatus, comprising:
at least one developing unit removing waste toner from a photosensitive medium using a cleaning unit and temporarily storing the waste toner therein; and
a waste toner storage tub adapted to communicate with the developing unit when the developing unit is mounted on a main body and to store the waste toner exhausted from the developing unit therein.

2. The image forming apparatus of claim 1, wherein
a plurality of connection parts in which the waste toner flows in the waste toner storage tub from the developing unit when the developing unit is mounted on the main body so that the waste toner storage tub communicates with the developing unit.

3. The image forming apparatus of claim 2, wherein
a connection valve is disposed in the at least one developing unit in which the waste toner flows in the waste toner storage tub while communicating with the connection parts when the developing unit is mounted on the main body.

4. The image forming apparatus of claim 3, wherein
the plurality of connection parts and the connection valve are check valves.

5. The image forming apparatus of claim 1, wherein
the waste toner storage tub is attachable to and removable from the main body.

6. The image forming apparatus of claim 2, wherein
an inlet portion extends from the waste toner storage tub to the plurality of connection parts.

7. The image forming apparatus of claim 6, wherein
the inlet portion extends substantially vertically from the waste toner storage tub.

8. The image forming apparatus of claim 6, wherein
the inlet portion extends substantially horizontally from the waste toner storage tub.

9. The image forming apparatus of claim 2, wherein
the plurality of connection parts are elastically biased, such that the plurality of connection parts are closed when not connected to the at least one developing unit and open when connected to the at least one developing unit.

10. The image forming apparatus of claim 3, wherein
the connection valve is elastically biased, such that the connection valve is closed when not connected to the plurality of connection parts and open when connected to the plurality of connection parts.

11. A method of storing waste toner in an image forming apparatus, comprising the steps of
connecting a waste toner storage tub to at least one developing unit;
transferring waste toner from the developing unit to the waste toner storage tub; and
removing the waste toner storage tub from the image forming apparatus.

12. The method of claim 11, further comprising
opening and closing a transfer path between the waste toner storage tub and the at least one developing unit by connecting and removing the waste toner storage tub to the at least one developing unit.
